(19) United States
(12) Patent Application Publication
(10) Pub. No.: US 2005/0016389 A1
(43) Pub. Date: Jan. 27, 2005

(54) Method and Apparatus For Making Sushi Rolls

(76) Inventor: Yutaka Kobayashi, Beaverton, OR (US)

Correspondence Address: SCOTT A. NELSON, 1740 SW LOBELIA, PORTLAND, OR, 97219, US

(21) Appl. No.: 10/604,501

(22) Filed: Jul. 25, 2003

(51) Int. Cl. A23P 1/00

(52) U.S. Cl. 99/450.1

(57) ABSTRACT

The present invention and method relates to an apparatus for forming and separating rolled sushi dishes. The device comprises a non-stick, flexible mat with slots to facilitate the cutting of the rolled food product. The slots are positioned perpendicular to the axis of flexibility of the mat so that the formed food product may be cut into cylindrical portions.

### BACKGROUND OF INVENTION

### TECHNICAL FIELD

The present invention relates to an apparatus and method for making Maki-zushi and other sushi products. More particularly, the present invention provides a flexible, slotted surface and method of forming and cutting cylindrical, sushi rolls such as Maki-zushi, as well as California Rolls or Inside Out Rolls.

### BACKGROUND OF THE INVENTION

In the traditional production and preparation of rolled sushi products, such as Maki-zushi, a significant amount of time and effort is required. Sushi rolls have traditionally consisted of thin sheets edible wrap known as nori, made of seaweed. Edible wraps made of soy and other comestible products have also been used. The edible wrap is topped with a layer of vinegared boiled rice and a second layer of crab, fish, avocado, vegetables or other traditional ingredients. The wrap, rice and toppings are then rolled by hand with a bamboo mat that has been wrapped in plastic to prevent foodstuffs from sticking to the mat, so as to tighten and consolidate the ingredients forming an elongated cylindrical roll. The plastic wrapped bamboo mat is then removed and the formed roll is cut laterally into smaller sections that will hold together when eaten by hand. This form of sushi is commonly referred to as the California Roll.

Recently a variation of this rolled sushi product known as the Inside Out Roll has gained popularity. The Inside Out Roll consists of the same and similar ingredients used to produce the California Roll but instead of the edible wrap surrounding the rice and ingredients, the rice is rolled around the edible wrap and fish, shrimp, avocado or other toppings are then placed on top of the formed rice roll. Again, a plastic wrapped bamboo mat is used at various stages to form and consolidate the ingredients into a configuration that will hold together when handled and is visually appealing when presented.

Currently restaurants desire to showcase the preparation of sushi dishes by their specialized chefs. The art of rolling the California and Inside Out Rolls require a great amount of skill, manual dexterity and a plurality of steps in order to produce the sushi rolls with adequate foodstuff filling and to cut and present a product that is aesthetically pleasing to the consumer. Unless one had proper training, it was extremely difficult to create a maki zushi roll of a given size, and a form with a desirable appearance. It is particularly difficult to make Inside Out Rolls, which could pass as the professional art in an expedient manner, and therefore maximize the amount of product a sushi chef could produce during a set amount of time.

The subject invention and method is deemed to overcome the shortcomings in the prior art.

### SUMMARY OF INVENTION

The present invention aims at an apparatus and method for the production of Maki sushi, in particular, sushi rolls known as California Rolls and Inside Out Rolls.

The fundamental novel feature of the present invention lies in the fact that a slotted, non-stick flexible surface will reduce the number of steps needed to produce the before mentioned sushi rolls.

The first object of the invention is to produce a sushi roll in an efficient manner so that consumers are quickly served while retaining the entertainment value of the performance of the sushi chef.

The second object of the invention is to maximize the output of a sushi chef so that the maximum number of consumers may be served during a given amount of time.

The above and further objects and novel features of the invention will more fully appear from the following description when the same is read in connection with the accompanying drawings. It is to be expressly understood, however, that the drawings are for purpose of illustration only and is not intended as a definition of the invention.

### BRIEF DESCRIPTION OF DRAWINGS

FIG. 1 is a perspective view of the flexible, slotted surface.

FIG. 2 is a perspective view illustrating the traditional process of assembling an Inside Out Roll.

FIG. 3 is a perspective view illustrating an assembled Inside Out Roll prior to the use of the present invention.

FIG. 4 is a perspective view illustrating the present invention being placed upon the assembled Inside Out Roll.

FIG. 5 is a perspective view illustrating the forming, tightening, consolidation of the assembled Inside Out Roll using the present invention.

FIG. 6 is a perspective view illustrating the user cutting the Inside Out Roll utilizing the perpendicular slots within the present invention.

FIG. 7 is a perspective view illustrating the finished Inside Out Roll presented on a dish.

### DETAILED DESCRIPTION

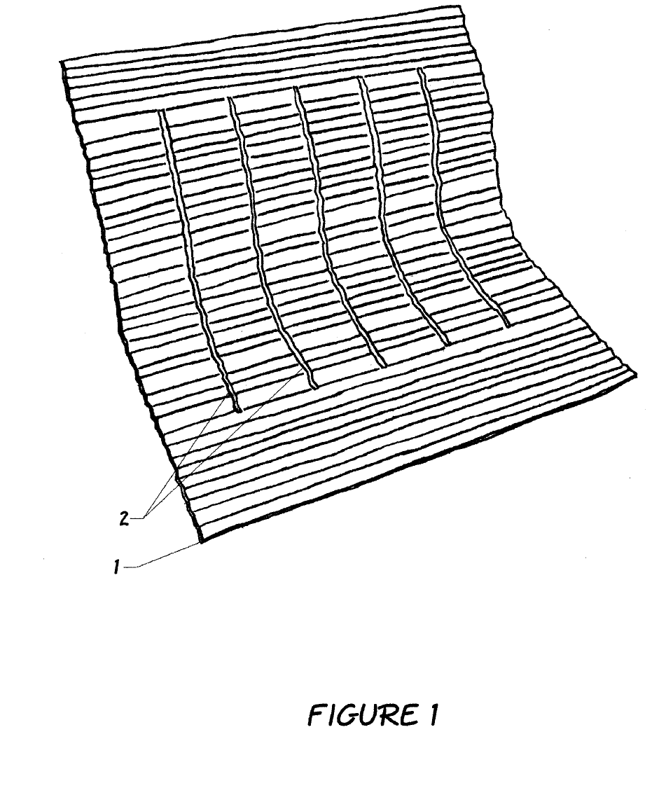

Referring to FIG. 1, the present invention of an apparatus and method of preparing Inside Out Rolls is illustrated consisting of a flexible, slotted surface, for forming, tightening, consolidating and facilitating the separation of associated rolled food items such as rice, vegetables, seafood and selected seasonings. It should be appreciated that the present invention can be utilized to form Sushi rolls and other associated rolled food products using any type of food items or comestible materials selected by the user for human consumption. The flexible slotted surface is configured to flex about a linear axis 1 with slots 2 perpendicular to this axis of flexibility.

The composition of the flexible surface would preferably be a non-stick, organic polymer. This polymer may be molded to resemble the traditional bamboo mat used for the preparation of Maki zushi. It should be appreciated that the present invention may be made of other materials that could be coated or impregnated with compounds that will serve the same purpose of providing a non-stick planar surface. For example, the present invention could be constructed using bamboo rods and a layer of plastic coated with adhesive to form a composite planar member that would perform the same functions as a molded product.

The number of slots constructed in the flexible surface would be consistent with the number and size of the pieces or portions of individual Inside Out Roll sections determined by the user to be served and consumed. However, it is foreseeable that the number of slots would vary for differing users and therefore the number of slots would be modified to reflect the desire of the respective user. For example, it is contemplated that the present invention could be commercialized as an individual serving size product for use in the preparation of Maki zushi in a restaurant. Furthermore, it is foreseeable that the number of slots found in the present invention may vary in number and position as serving portions and comestible materials used to comprise the rolled food product may vary according to taste, preference and economics of the user.

METHOD OF MAKING INSIDE OUT ROLLS OF THE PRESENT INVENTION. The present invention also comprises a method of making Inside Out Rolls using the apparatus as described above. In a preferred embodiment of the methodology employed for making Inside Out Rolls, the slotted, flexible planar member is used to form, tighten, consolidate and facilitate the preparation and separation of selected ingredients (e.g. a fish portion, a seafood portion, rice, vegetables selected seasoning, as well as any other type of comestible material consumed by humans) as well as any other ingredient or combination of ingredients typically used in the making of Inside Out Rolls.

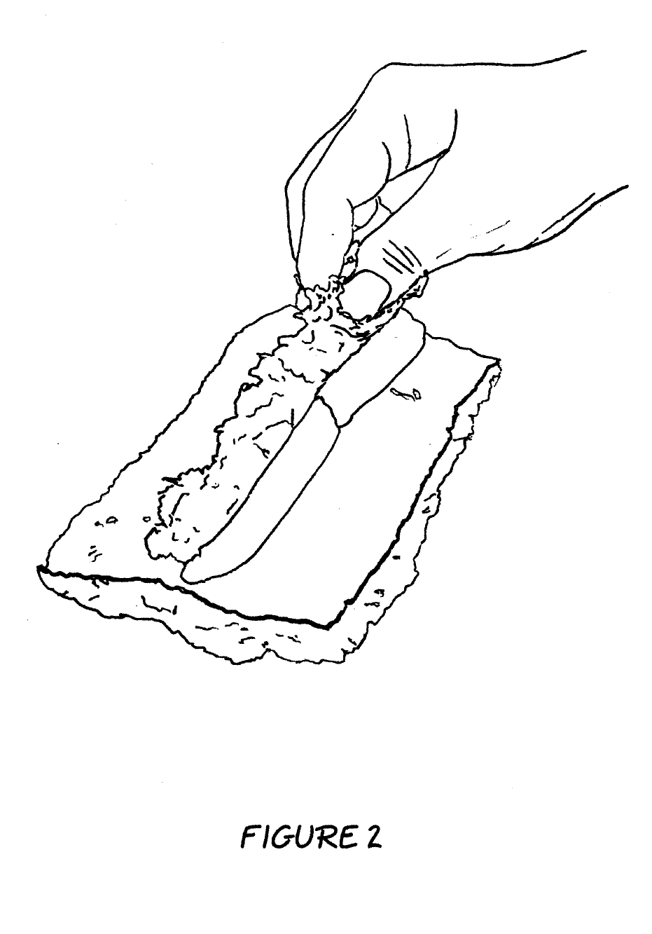

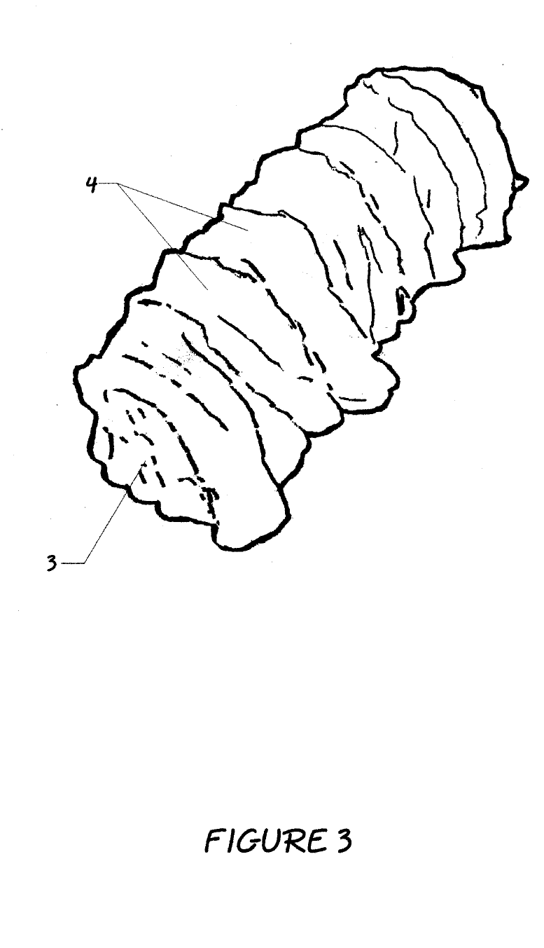

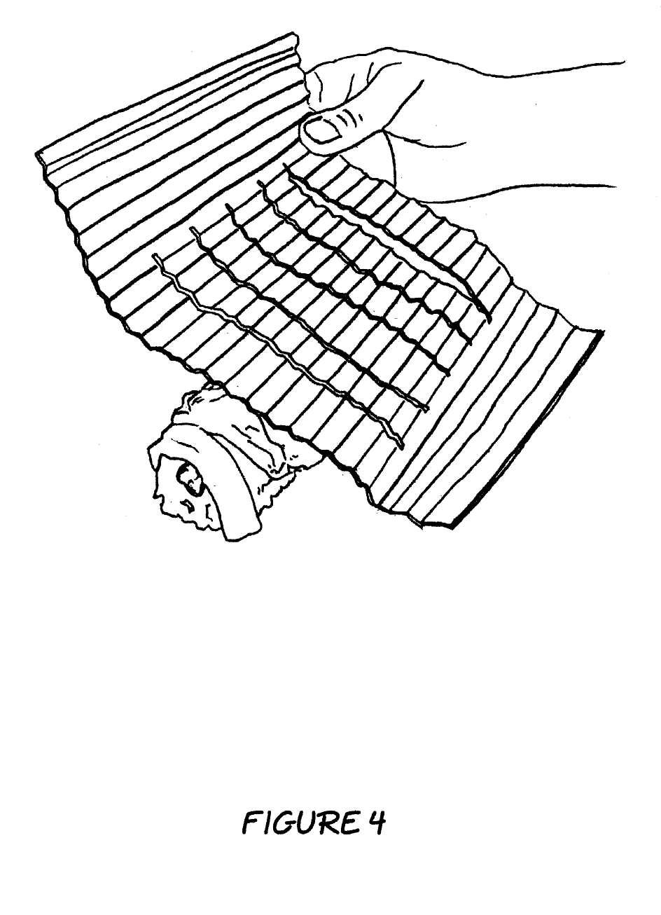

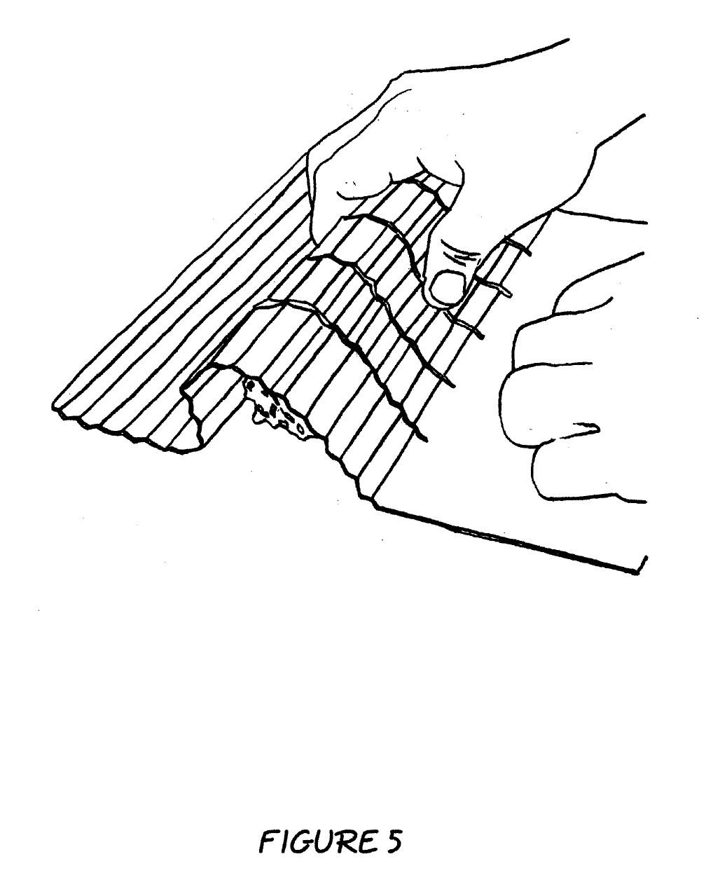

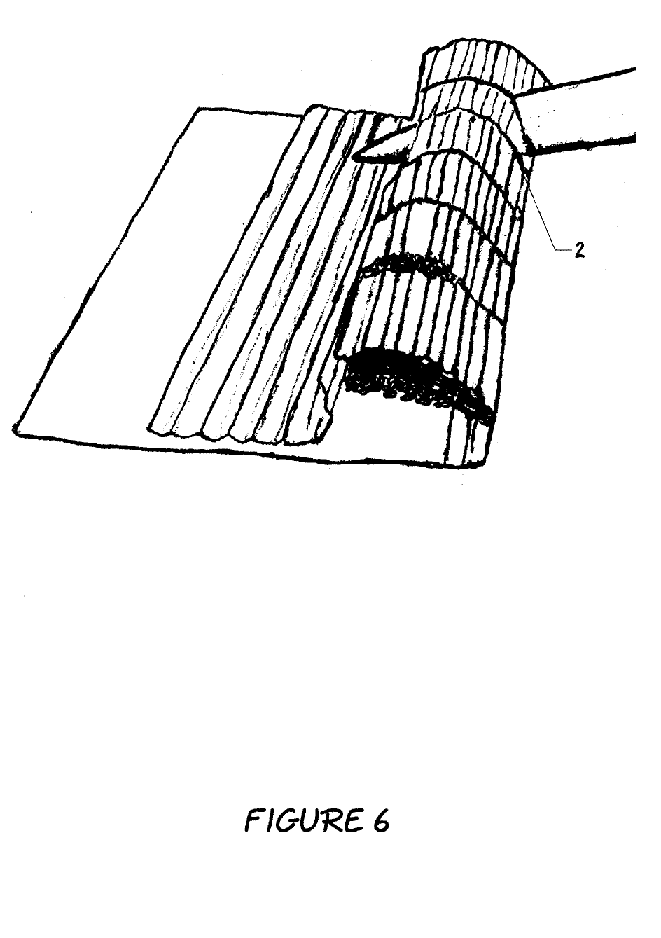

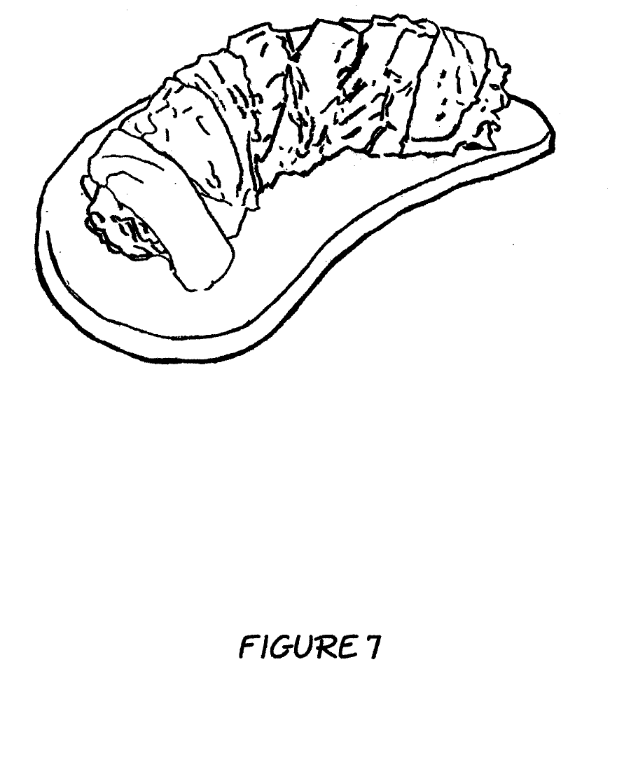

Referring to FIGS. 2 through 7, the Inside Out Roll is initially constructed by the traditional methods FIG. 2, into a preliminary form consisting of a core of rice and food wrap 3 and topped with tuna, avocado, vegetables, seasonings 4 FIG. 3. The user places the slotted, non-stick, flexible mat over the assembled rice, vegetable, seafood, and seasonings, etc. foodstuff roll FIG. 4. The user exerts pressure on the foodstuff roll thereby forming, tightening, and consolidating the foodstuffs roll into a compact, elongated, cylindrical form FIG. 5. Before removing the present invention from the foodstuffs roll, the user cuts the Inside Out Roll utilizing the perpendicular slots into the desired number of sections FIG. 6. After the Inside Out Roll has been cut, the user can perform a final shaping and consolidation of the foodstuff items prior to the removal of the present invention. Finally, the present invention is removed and the finished Inside Out Roll is presented to the consumer FIG. 7. This embodiment provides substantial time saving in the making of properly formed and dimensioned portions of Inside Out Rolls by the user. In addition, the non-stick surface of the invention will aid in the cleaning of the invention by allowing the invention to be cleaned in a dishwasher as opposed to hand washing or the continual replacement of the plastic wrap about a traditional bamboo mat.

Although the invention has been described with particular reference to a certain preferred embodiment thereof, variations and modifications can be effected within the spirit and scope of the following claims.

1. an apparatus for the making of associated rolled food products comprising:
a. a flexible, planar member with the axis of flexibility parallel to one edge of the said member.
b. a plurality of slots through the surface, perpendicular to said axis of flexibility, said slots extending less than the full distance from said edge to parallel, opposing edge.

2. The apparatus as defined in claim 1 wherein said flexible member is formed of an organic polymer material.

3. The apparatus as defined in claim 1 wherein said flexible planar member is made from bamboo and coated with an organic polymer material.

4. The apparatus as defined in claim 1 wherein said slots are of sufficient size to accommodate a cutting means.

5. The apparatus as defined in claim 1 wherein the width of said slots are of sufficient size to allow a cutting means to separate the rolled food product without said cutting means coming in contacting with sides of said slots.

6. The apparatus as defined in claim 1 wherein edges of said slots are rounded as to deflect edges of cutting means.

7. A method of making associated rolled food products comprising the steps of:
a. forming, tightening and consolidating predetermined foodstuffs using said flexible planar member into elongated, cylindrical tubes
b. separating said tubes with a cutting means utilizing said slots into individual portions.

8. The method of claim 7 wherein said cutting means is a knife.
